(19) United States
(12) Patent Application Publication
(10) Pub. No.: US 2023/0238509 A1
(43) Pub. Date: Jul. 27, 2023

(54) MANUFACTURE OF ELECTRODES FOR ENERGY STORAGE DEVICES

(71) Applicant: FastCAP Systems Corporation, Wakefield, MA (US)

(72) Inventors: Ji Chen, Malden, MA (US); Wanjun Ben Cao, Boston, MA (US); Kitae Park, Brookline, MA (US); Nicolo Brambilla, Brookline, MA (US); Jin Yan, Malden, MA (US)

(21) Appl. No.: 17/941,424

(22) Filed: Sep. 9, 2022

Related U.S. Application Data
(60) Provisional application No. 63/242,322, filed on Sep. 9, 2021.

(51) Int. Cl. H01M 4/133; H01M 4/131; H01M 4/04

(52) U.S. Cl. CPC H01M 4/133; H01M 4/131; H01M 4/0404; H01M 4/0435; H01M 4/0416

(57) ABSTRACT

A method for fabricating an electrode for an energy storage device is provided. The method includes heating a mixture of solvent and materials for use as energy storage media; adding active material to the mixture; adding dispersant to the mixture to provide a slurry; coating a current collector with the slurry; and calendering the coating of slurry on the current collector to provide the electrode.

### CROSS-REFERENCE TO RELATED APPLICATION

The present application claims priority benefit to a provisional application which was filed on Sep. 9, 2021, and assigned Ser. No. 63/242,322. The entire contents of the foregoing provisional application is incorporated herein by reference.

### BACKGROUND OF THE INVENTION

### 1. Field of the Invention

The invention disclosed herein relates to energy storage devices, and in particular to the manufacture of electrodes for batteries and ultracapacitors.

### 2. Description of the Related Art

The increasing use of renewable energy has brought many benefits as well as challenges. Perhaps the most significant challenge is development of efficient energy storage. In order to truly capitalize on renewable energy sources, inexpensive and high-power energy storage is needed. In fact, a myriad of other industries would benefit from improved energy storage. One example is the automotive industry with the increasing drive to electric and hybrid vehicles.

Perhaps the most pervasive and convenient form of energy storage is that of the battery. Batteries share a variety of features with electrolytic double layer capacitors (EDLC). For example, such devices typically include a layer of anode material separated from a layer of cathode material by a separator. Electrolyte provides for ionic transport between these electrodes to provide the energy.

In the prior art, electrodes of energy storage devices typically include some form of binder mixed into the energy storage materials. That is, the binder is essentially a form of glue ensures adhesion to a current collector. Unfortunately, the binder material, which provides for physical integrity of the electrode, is typically non-conductive and results poor performance and degraded operation over time. Often, the binder material is toxic and may be expensive.

Many modern applications need improved performance for at least one of energy density, usable life (i.e., cyclability), safety, equivalent series resistance (ESR), cost of manufacture, physical strength and other such aspects. Further, it is preferable that improved devices operate reliably over wide temperature range. Use of binder materials detracts from these performance requirements. Thus, improving the technology used in fabrication of the electrodes (e.g., the anode and the cathode) offers the greatest opportunities to improve the performance of the energy storage device in which the electrodes are used.

As one might imagine, space within an energy storage device comes at a premium. That is, void spaces simply result in lost opportunities for incorporation of energy storage materials. Thus, efficient manufacturing techniques are vital for development of high performance energy storage devices. As one example, application of energy storage media on to a current collector may often result in electrodes with rough surfaces, essentially creating voids within the energy storage device.

Thus, what are needed are methods and apparatus to ensure uniform dispersion of slurries onto current collectors when fabricating energy storage devices.

### SUMMARY OF THE INVENTION

In one embodiment, a method for fabricating an electrode for an energy storage device is provided. The method includes heating a mixture of solvent and materials for use as energy storage media; adding active material to the mixture; adding dispersant to the mixture to provide a slurry; coating a current collector with the slurry; and calendaring the coating of slurry on the current collector to provide the electrode.

In another embodiment, an energy storage device incorporating the electrode is provided.

### BRIEF DESCRIPTION OF THE DRAWINGS

The features and advantages of the invention are apparent from the following description taken in conjunction with the accompanying drawings in which:

FIG. 1 is a schematic cutaway diagram depicting aspects of a prior art energy storage device (ESD);

FIG. 2 is a schematic cutaway diagram depicting aspects of a prior art storage cell of the energy storage device (ESD) of FIG. 1;

FIG. 3A depicts aspects of a fully charged energy storage device (ESD); it also depicts aspects of ionic transport between electrodes in the storage cell of FIG. 2;

FIG. 3B depicts aspects of a partially charged energy storage device (ESD);

FIG. 3C depicts aspects of an almost fully discharged energy storage device (ESD);

FIG. 4 is a flow chart depicting an example of a process for fabrication of an electrode according to the teachings herein

FIG. 5 is a schematic diagram depicting aspects of the materials assembled during the disclosed process seen in the FIG. 4;

FIG. 6 is a schematic diagram depicting aspects of the materials assembled during the disclosed process seen in the FIG. 4;

FIG. 7 is a schematic diagram depicting aspects of the materials assembled during the disclosed process seen in the FIG. 4;

FIG. 8 is a schematic diagram depicting aspects of the materials assembled during the disclosed process seen in the FIG. 4;

FIGS. 9A and 9B are photomicrographs of the materials assembled in the process set forth in FIG. 4;

FIGS. 10A and 10B are photomicrographs of the materials assembled in the process set forth in FIG. 4;

FIGS. 11A and 11B are photomicrographs of the materials assembled in the process set forth in FIG. 4;

FIGS. 12A and 12B are photomicrographs of the materials assembled in the process set forth in FIG. 4;

FIGS. 13A and 13B are photomicrographs of the materials assembled in the process set forth in FIG. 4;

FIG. 14 is a photomicrograph of the materials assembled in the process set forth in the FIG. 4;

FIGS. 15A and 15B are photomicrographs of the materials assembled in the process set forth in FIG. 4;

FIG. 16 is a photomicrograph of the materials assembled in the process set forth in FIG. 4;

FIGS. 17, 18, 19 and 20 are graphs depicting aspects of electrical performance of energy storage cells assembled with the materials disclosed herein;

FIG. 21 is a schematic diagram depicting aspects of an energy storage cells assembled with the materials disclosed herein;

FIGS. 22, 23, 24, 25 and 26 are graphs depicting aspects of electrical performance of energy storage cells assembled with the materials disclosed herein;

FIG. 27 is a series of photographs depicting electrode materials assembled with the materials disclosed herein;

FIG. 28 is a graph that depicts the discharge capacity versus discharge C-rate for a storage device that contains the conventional electrode (polyvinylidene fluoride (PVDF)) and the storage device that contains an electrode that has polyvinylpyrrolidone (PVP);

FIG. 29A is a plot that depicts potential vs Li/Li+ versus specific capacity for the electrode containing PVP;

FIG. 29B is a plot that depicts potential vs Li/Li+ versus specific capacity for the conventional electrode containing PVDF; and

FIG. 30 depicts a plot of discharge energy (expressed as a percentage) versus cycle number.

### DETAILED DESCRIPTION OF THE INVENTION

Disclosed herein are methods and apparatus for providing electrodes useful in energy storage devices. Generally, application of the technology disclosed can result in energy storage devices capable of delivering high power, high energy, exhibiting a long lifetime and operating over a wide range of environmental conditions. The technology disclosed is deployable in high-volume manufacturing for a variety of energy storage devices and in a variety of forms. Advantageously, the techniques result in lower costs for fabrication of energy storage devices. The electrodes are free of polyvinylidene fluoride and solvents such as N-methylpyrrolidone are not used in the preparation of the electrodes.

The technology may be used in an energy storage device that is a battery, an ultracapacitor or any other similar type of device making use of electrodes for energy storage. Prior to introducing the technology, some context is provided by way of definitions and an overview of energy storage technology.

As discussed herein, the term “energy storage device” (also referred to as an “ESD”) generally refers to an electrochemical cell. An electrochemical cell is a device capable of either generating electrical energy from chemical reactions or using electrical energy to cause chemical reactions. Electrochemical cells which generate electric current are referred to as “voltaic cells” or “galvanic cells,” and those that generate chemical reactions, via electrolysis for example, are called electrolytic cells. A common example of a galvanic cell is a standard 1.5 volt cell designated for consumer use. A battery consists of one or more cells, connected in parallel, series or series-and-parallel pattern. A secondary cell, commonly referred to as a rechargeable battery, is an electrochemical cell that can be run as both a galvanic cell and as an electrolytic cell. This is used as a convenient way to store electricity, when current flows one way, the levels of one or more chemicals build up (that is, while charging). Conversely, the chemicals reduce while the cell is discharging and the resulting electromotive force may be used to do work. One example of a rechargeable battery is a lithium-ion battery, some embodiments of which are discussed herein.

As a matter of convention, an electrode in an electrochemical cell is referred to as either an “anode” or a “cathode.” The anode is the electrode at which electrons leave the electrochemical cell and oxidation occurs (indicated by a minus symbol, “−”), and the cathode is the electrode at which electrons enter the cell and reduction occurs (indicated by a plus symbol, “+”). Each electrode may become either the anode or the cathode depending on the direction of current through the cell. Given the variety of configurations and states for energy storage devices (ESD) generally, this convention is not limiting of the teachings herein and use of such terminology is merely for purposes of introducing the technology. Accordingly, it should be recognized that the terms “cathode,” “anode” and “electrode” are interchangeable in at least some instances. For example, aspects of the techniques for a fabrication of an active layer in an electrode may apply equally to anodes and cathodes. More specifically, the chemistry and/or electrical configuration discussed in any specific example may inform use of a particular electrode as one of the anode or cathode.

Generally, examples of energy storage device (ESD) disclosed herein are illustrative. That is, the energy storage device (ESD) is not limited to the embodiments disclosed herein.

More specific examples of energy storage device (ESD) include supercapacitors such as double-layer capacitors (devices storing charge electrostatically), psuedocapacitors (which store charge electrochemically) and hybrid capacitors (which store charge electrostatically and electrochemically). Generally, electrostatic double-layer capacitors (EDLCs) use carbon electrodes or derivatives with much higher electrostatic double-layer capacitance than electrochemical pseudocapacitance, achieving separation of charge in a Helmholtz double layer at the interface between the surface of a conductive electrode and an electrolyte. Generally, electrochemical pseudocapacitors use metal oxide or conducting polymer electrodes with a high amount of electrochemical pseudocapacitance additional to the double-layer capacitance. Pseudocapacitance is achieved by Faradaic electron charge-transfer with redox reactions, intercalation or electrosorption. Hybrid capacitors, such as the lithium-ion capacitor, use electrodes with differing characteristics: one exhibiting mostly electrostatic capacitance and the other mostly electrochemical capacitance.

Other examples of energy storage devices (ESD) include rechargeable batteries, storage batteries, or secondary cells which are a type of electrical battery that can be charged, discharged into a load, and recharged many times. During charging, the positive active material is oxidized, producing electrons, and the negative material is reduced, consuming electrons. These electrons constitute the current flow from the external circuit. Generally, the electrolyte serves as a buffer for internal ion flow between the electrodes (e.g., anode and cathode). Battery charging and discharging rates are often discussed by referencing a “C” rate of current. The C rate is that which would theoretically fully charge or discharge the battery in one hour. “Depth of discharge” (DOD) is normally stated as a percentage of the nominal ampere-hour capacity. For example, zero percent (0%) DOD means no discharge.

Additional context is provided with regard to FIGS. 1 through 3 which provide an overview of aspects of an energy storage devices (ESD) 10.

In FIG. 1, a cross section of an energy storage device (ESD) 10 is shown. The energy storage device (ESD) 10 includes a housing 11. The housing 11 has two terminals 8 disposed on an exterior thereof. The terminals 8 provide for internal electrical connection to a storage cell 12 contained within the housing 11 and for external electrical connection to an external device such as a load or charging device (not shown).

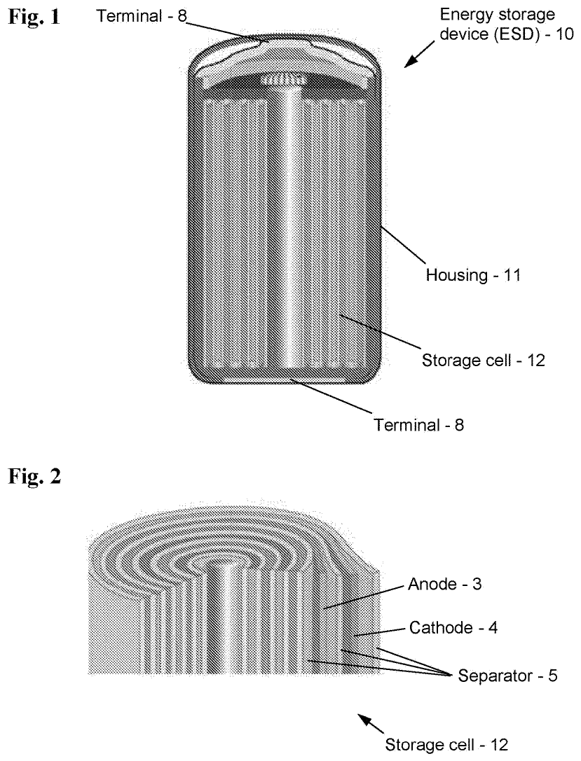

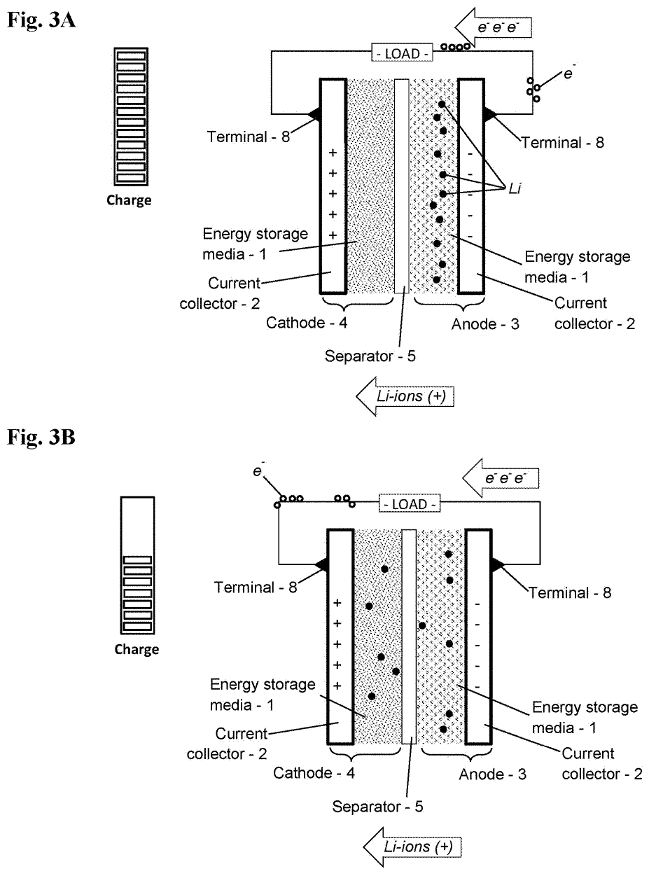

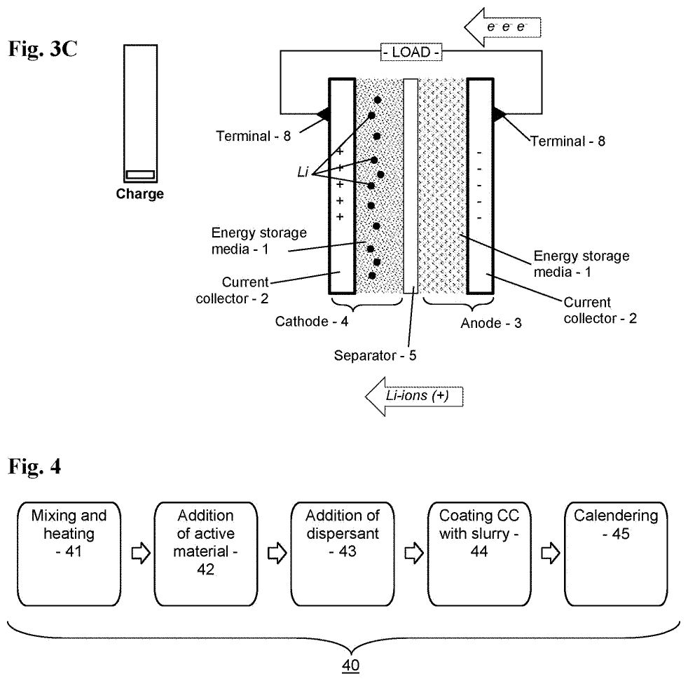

A cutaway portion of the storage cell 12 is depicted in FIG. 2. As shown in this illustration, the storage cell 12 includes a multi-layer roll of energy storage materials. That is, sheets or strips of energy storage materials are rolled together into a roll format. The roll of energy storage materials include opposing electrodes referred to as an “anode 3” and as a “cathode 4.” The anode 3 and the cathode 4 are separated by a separator 5. Not shown in the illustration but included as a part of the storage cell 12 is an electrolyte. Generally, the electrolyte permeates or wets the cathode 4 and the anode 3 and facilitates migration of ions within the storage cell 12. Ionic transport is illustrated conceptually in FIG. 3.

FIGS. 3A, 3B and 3C, collectively referred to herein as FIG. 3, are conceptual diagrams depicting aspects of cell chemistry as a function of the state of charge for the energy storage device (ESD) 10. Specifically, in FIG. 3, a discharge sequence is shown for the energy storage device (ESD) 10 is shown. In this series, the energy storage device (ESD) 10 is a lithium-ion battery. The battery includes the anode 3, the cathode 4, the separator 5, and electrolyte 6 (more on each of these elements is presented below). Generally, the anode 3 and the cathode 4 store lithium.

In FIG. 3A, aspects of a fully charged energy storage device (ESD) 10 are shown. In this illustration, the anode 3 contains energy storage media 1 disposed on a current collector 2. The energy storage media 1 of the anode 3 for a fully charged energy storage device (ESD) 10 substantially contains all of the lithium within the storage cell 12. Similar in construction, the cathode 4 contains energy storage media 1 disposed on a current collector 2.

A load (for example, electronics such as a cell phone, a computer, a tool, or automobile, not shown) is connected to and draws energy from the energy storage device (ESD) 10, electrons (e−) are drawn from the anode 3. Positively charged lithium ions migrate within the storage cell 12 to the cathode 4. This causes depletion of charge as shown in the charge-meter depicted in FIG. 3B. When the energy storage device (ESD) 10 is fully depleted, substantially all of the lithium ions have migrated to the cathode 4, as shown in FIG. 3C.

Swapping a charging device for the load and energizing the charging device causes flow of electrons (e−) to the anode 3 and the attendant migration of the lithium ions from the cathode 4 to the anode 3. Whether discharging or charging, the separator 5 blocks the flow of electrons within the energy storage device (ESD) 10.

In a typical lithium-ion battery, the anode 3 may be made substantially from a carbon based matrix with lithium intercalated into the carbon based matrix. In the prior art, the carbon based matrix often includes a mixture of graphite and binder material. In the prior art, the cathode 4 often includes a lithium metal oxide based material along with a binder material. Conventional processes for fabrication of the electrodes calls for development of a mixture of materials which are then applied to the current collector 2 as the energy storage media 1. Quite often, agglomerations and inconsistencies within the slurry result in a surface of the electrode that is rough or includes peaks and valleys. Problems found in the prior art and arising with the development of slurries of energy storage media 1 can be remedied with fabrication of a slurry according to the teachings herein. An example of a process for mixing slurry is provided in FIG. 4.

In FIG. 4, as an overview, an example of a process for fabrication of an electrode 40 according to the teachings herein is provided. In a first step 41, base materials are mixed and heated. In a second step 42, an addition of active material is made while heating and mixing is ongoing. In a third step 43, an addition of dispersant is made while heating and mixing is ongoing. In a fourth step 44, the resulting mixture is applied to a prepared current collector. In a fifth step 45, the coated current collector is subjected to calendaring.

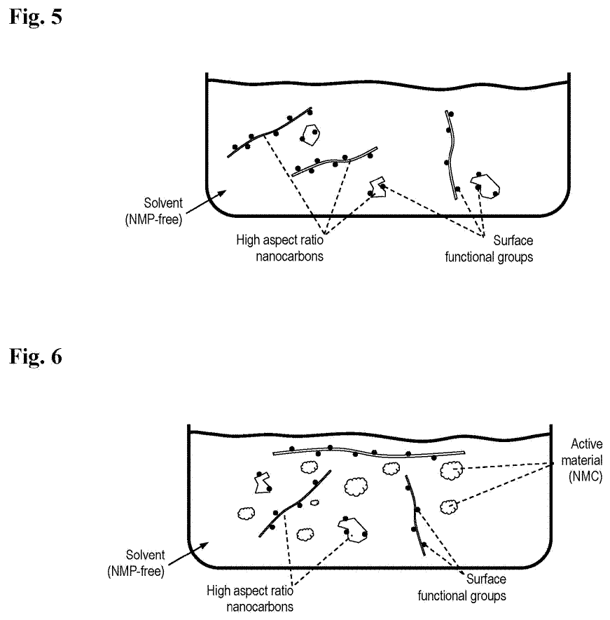

Referring to FIG. 5, further detail regarding the first step 41 is introduced. In the first step 41, a carbon dispersion is prepared. The carbon dispersion includes high aspect ratio nanocarbon materials (or “nanocarbons”) which may be functionalized by the process or provided as functionalized materials. In this example, the first step 41 includes heating to temperatures between about 35 degrees Celsius and 70 degrees Celsius.

As used herein, the term “high aspect ratio carbon elements” and other similar terms refers to carbonaceous elements having a size in one or more dimensions (the “major dimension(s)”) significantly larger than the size of the element in a transverse dimension (the “minor dimension”).

For example, in some embodiments, the high aspect ratio carbon elements may include flake or plate shaped elements having two major dimensions and one minor dimension. For example, in some such embodiments, the ratio of the length of each of the major dimensions may be at least 5 times, 10 times, 100 times, 500 times, 1,000 times, 5,000 times, 10,000 times or more of that of the minor dimension. Exemplary elements of this type include graphene sheets or flakes.

In some embodiments, the high aspect ratio carbon elements may include elongated rod or fiber shaped elements having one major dimension and two minor dimensions. For example, in some such embodiments, the ratio of the length of the major dimensions may be at least 5 times, 10 times, 100 times, 500 times, 1,000 times, 5,000 times, 10,000 times or more of that of each of the minor dimensions. Exemplary elements of this type include carbon nanotubes, bundles of carbon nanotubes, carbon nanorods, and carbon fibers.

In some embodiments, the high aspect ratio carbon elements may include single wall nanotubes (SWNT), double wall nanotubes (DWNT), or multiwall nanotubes (MWNT), carbon nanorods, carbon fibers or mixtures thereof. The high aspect ratio carbon elements are also termed nanosized conductive fillers or electrically conductive fillers. In some embodiments, the high aspect ratio carbon elements may be formed of interconnected bundles, clusters, or aggregates of CNTs or other high aspect ratio carbon materials. In some embodiments, the high aspect ratio carbon elements may include graphene in sheet, flake, or curved flake form, and/or formed into high aspect ratio cones, rods, and the like.

SWNTs used in the composition may be produced by laser-evaporation of graphite, carbon arc synthesis or the high-pressure carbon monoxide conversion process (HIPCO) process. These SWNTs generally have a single wall comprising a graphene sheet with outer diameters of about 0.7 to about 2.4 nanometers (nm). SWNTs having aspect ratios of greater than or equal to about 5, preferably greater than or equal to about 100, more preferably greater than or equal to about 1000 are generally utilized in the high aspect ratio carbon elements. While the SWNTs are generally closed structures having hemispherical caps at each end of the respective tubes, it is envisioned that SWNTs having a single open end or both open ends may also be used. The SWNTs generally comprise a central portion, which is hollow, but may be filled with amorphous carbon.

In an exemplary embodiment, the purpose of dispersion of the SWNTs in an organic polymer is to disentangle the SWNTs so as to obtain an effective aspect ratio that is as close to the aspect ratio of the SWNT as possible. The ratio of the effective aspect ratio to the aspect ratio is a measure of the effectiveness of dispersion. The effective aspect ratio is a value that is twice the radius of gyration of a single SWNT divided by the outer diameter of the respective individual nanotube. It is generally desirable for the average value of ratio of the effective aspect ratio to the aspect ratio to be greater than or equal to about 0.5, preferably greater than or equal to about 0.75, and more preferably greater than or equal to about 0.90, as measured in an electron micrograph at a magnification of greater than or equal to about 10,000.

In one embodiment, the SWNTs may exist in the form of rope-like-aggregates. These aggregates are commonly termed “ropes” and are formed as a result of Van der Waal's forces between the individual SWNTs. The individual nanotubes in the ropes may slide against one another and rearrange themselves within the rope in order to minimize the free energy. Ropes generally having between 10 and 10⁵ nanotubes may be used in the compositions. Within this range, it is generally desirable to have ropes having greater than or equal to about 100, preferably greater than or equal to about 500 nanotubes. Also desirable, are ropes having less than or equal to about 104 nanotubes, preferably less than or equal to about 5,000 nanotubes.

In yet another embodiment, it is desirable for the SWNT ropes to connect each other in the form of branches after dispersion. This results in a sharing of the ropes between the branches of the SWNT networks (or the carbon nanotube network) to form a 3-diminsional network in the organic polymer matrix. A distance of about 10 nm to about 10 micrometers may separate the branching points in this type of network. It is generally desirable for the SWNTs to have an inherent thermal conductivity of at least 2000 Watts per meter Kelvin (W/m-K) and for the SWNT ropes to have an inherent electrical conductivity of 10⁴ Siemens/centimeter (S/cm). It is also generally desirable for the SWNTs to have a tensile strength of at least 80 gigapascals (GPa) and a stiffness of at least about 0.5 tarapascals (TPa).

In another embodiment, the SWNTs may comprise a mixture of metallic nanotubes and semi-conducting nanotubes. Metallic nanotubes are those that display electrical characteristics similar to metals, while the semi-conducting nanotubes are those, which are electrically semi-conducting. In general, the manner in which the graphene sheet is rolled up produces nanotubes of various helical structures. Zigzag and armchair nanotubes constitute two possible confirmations. In order to minimize the quantity of SWNTs utilized in the storage device, it is generally desirable to have the composition comprise as large a fraction of metallic SWNTs. It is generally desirable for the SWNTs used in the composition to comprise metallic nanotubes in an amount of greater than or equal to about 1 wt %, preferably greater than or equal to about 20 wt %, more preferably greater than or equal to about 30 wt %, even more preferably greater than or equal to about 50 wt %, and most preferably greater than or equal to about 99.9 wt % of the total weight of the SWNTs. In certain situations, it is generally desirable for the SWNTs used in the composition to comprise semi-conducting nanotubes in an amount of greater than or equal to about 1 wt %, preferably greater than or equal to about 20 wt %, more preferably greater than or equal to about 30 wt %, even more preferably greater than or equal to about 50 wt %, and most preferably greater than or equal to about 99.9 wt % of the total weight of the SWNTs.

SWNTs are generally used in amounts of about 0.001 to about 80 wt % of the total weight of the slurry when desirable. The slurry comprises the high aspect ratio carbon elements, the anode active material or cathode active material (depending upon whether the slurry is used to produce the anode active layer or the cathode active layer), the surface treatment composition, any optional binders and a solvent (typically water and/or alcohol). Within this range, SWNTs are generally used in amounts greater than or equal to about 0.25 wt %, preferably greater or equal to about 0.5 wt %, more preferably greater than or equal to about 1 wt % of the total weight of the slurry. SWNTs are furthermore generally used in amounts less than or equal to about 30 wt %, preferably less than or equal to about 10 wt %, more preferably less than or equal to about 5 wt % of the total weight of the slurry.

In one embodiment, the SWNTs may contain production related impurities. Production related impurities present in SWNTs as defined herein are those impurities, which are produced during processes substantially related to the production of SWNTs. As stated above, SWNTs are produced in processes such as, for example, laser ablation, chemical vapor deposition, carbon arc, high-pressure carbon monoxide conversion processes, or the like. Production related impurities are those impurities that are either formed naturally or formed deliberately during the production of SWNTs in the aforementioned processes or similar manufacturing processes. A suitable example of a production related impurity that is formed naturally are catalyst particles used in the production of the SWNTs. A suitable example of a production related impurity that is formed deliberately is a dangling bond formed on the surface of the SWNT by the deliberate addition of a small amount of an oxidizing agent during the manufacturing process.

The nanosized conductive filler are those having at least one dimension less than or equal to about 1,000 nm. The nanosized conductive fillers may be 1, 2 or 3-dimensional and may exist in the form of powder, drawn wires, strands, fibers; tubes, nanotubes, rods, whiskers, flakes, laminates, platelets, ellipsoids, discs, spheroids, and the like, or combinations comprising at least one of the foregoing forms. They may also have fractional dimensions and may exist in the form of mass or surface fractals.

Suitable examples of nanosized conductive fillers (also referred to herein as high aspect ratio carbon elements) are multiwall carbon nanotubes (MWNTs), vapor grown carbon fibers (VGCF), carbon black, graphite, conductive metal particles, conductive metal oxides, metal coated fillers, nanosized conducting organic/organometallic fillers, conductive polymers, and the like, and combinations comprising at least one of the foregoing nanosized conductive fillers.

MWNTs derived from processes such as laser ablation and carbon arc synthesis that are not directed at the production of SWNTs, may also be used in the compositions. MWNTs have at least two graphene layers bound around an inner hollow core. Hemispherical caps generally close both ends of the MWNTs, but it may be desirable to use MWNTs having only one hemispherical cap or MWNTs, which are devoid of both caps. MWNTs generally have diameters of about 2 to about 50 nm. Within this range, it is generally desirable to use MWNTs having diameters less than or equal to about 40, preferably less than or equal to about 30, and more preferably less than or equal to about 20 nm. When MWNTs are used, it is preferred to have an average aspect ratio greater than or equal to about 5; preferably greater than or equal to about 100, more preferably greater than or equal to about 1000.

MWNTs are generally used in amounts of about 0.001 to about 50 wt % of the total weight of the slurry when desirable. Within this range, MWNTs are generally used in amounts greater than or equal to about 0.25 wt %, preferably greater or equal to about 0.5 wt %, more preferably greater than or equal to about 1 wt % of the total weight of the slurry. MWNTs are furthermore generally used in amounts less than or equal to about 30 wt %, preferably less than or equal to about 10 wt %, more preferably less than or equal to about 5 wt % of the total weight of the slurry.

Vapor grown carbon fibers or small graphitic or partially graphitic carbon fibers, also referred to as vapor grown carbon fibers (VGCF), having diameters of about 3.5 to about 100 nanometers (nm) and an aspect ratio greater than or equal to about 5 may also be used. These vapor grown carbon fibers typically contain an amorphous coating on the exterior surface of the graphitic carbon fiber surface. When VGCF are used, diameters of about 3.5 to about 70 nm are preferred, with diameters of about 3.5 to about 50 nm being more preferred, and diameters of about 3.5 to about 25 nm most preferred. It is also preferable to have average aspect ratios greater than or equal to about 100 and more preferably greater than or equal to about 1000.

VGCF are generally used in amounts of about 0.001 to about 50 wt % of the total weight of the slurry when desirable. Within this range, VGCF are generally used in amounts greater than or equal to about 0.25 wt %, preferably greater or equal to about 0.5 wt %, more preferably greater than or equal to about 1 wt % of the total weight of the slurry. VGCF are furthermore generally used in amounts less than or equal to about 30 wt %, preferably less than or equal to about 10 wt %, more preferably less than or equal to about 5 wt % of the total weight of the high aspect ratio conductive element.

Both the SWNTs and the other carbon nanotubes (i.e., the MWNTs and the VGCF) utilized as the high aspect ratio carbon elements may also be derivatized with functional groups to improve compatibility and facilitate the mixing with the organic polymer. The SWNTs and the other carbon nanotubes may be functionalized on either the graphene sheet constituting the sidewall, a hemispherical cap or on both the side wall as well as the hemispherical endcap. Functionalized SWNTs and the other carbon nanotubes are those having the formula [CₙH_{L}]Rₘ wherein n is an integer, L is a number less than 0.1 n, m is a number less than 0.5 n, and wherein each of R is the same and is selected from —SO₃H, —NH₂, —OH, —C(OH)R′, —CHO, —CN, —C(O)Cl, —C(O)SH, —C(O)OR′, —SR′, —SiR₃′, —Si(OR′)_{y}R′_{(3-y)}, —R″, —AlR₂′, halide, ethylenically unsaturated functionalities, epoxide functionalities, or the like, wherein y is an integer equal to or less than 3, R′ is hydrogen, alkyl, aryl, cycloalkyl, alkaryl, aralkyl, cycloaryl, poly(alkylether), bromo, chloro, iodo, fluoro, amino, hydroxyl, thio, phosphino, alkylthio, cyano, nitro, amido, carboxyl, heterocyclyl, ferrocenyl, heteroaryl, fluoro substituted alkyl, ester, ketone, carboxylic acid, alcohol, fluoro-substituted carboxylic acid, fluoro-alkyl-triflate, or the like, and R″ is fluoroalkyl, fluoroaryl, fluorocycloalkyl, fluoroaralkyl, cycloaryl, or the like. The carbon atoms, Cₙ, are surface carbons of a carbon nanotube. In both, uniformly and non-uniformly substituted SWNTs and other carbon nanotubes, the surface atoms Cn are reacted.

Non-uniformly substituted SWNTs and other carbon nanotubes may also be used in the conductive precursor composition and/or the conductive composition. These include compositions of the formula (I) shown above wherein n, L, m, R and the SWNT itself are as defined above, provided that each of R does not contain oxygen, or, if each of R is an oxygen-containing group, COOH is not present.

Also included are functionalized SWNTs and other carbon nanotubes having the formula

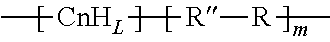

where n, L, m, R″ and R have the same meaning as above. Most carbon atoms in the surface layer of a carbon nanotube are basal plane carbons. Basal plane carbons are relatively inert to chemical attack. At defect sites, where, for example, the graphitic plane fails to extend fully around the carbon nanotube, there are carbon atoms analogous to the edge carbon atoms of a graphite plane. The edge carbons are reactive and must contain some heteroatom or group to satisfy carbon valency.

The substituted SWNTs and other carbon nanotubes described above may advantageously be further functionalized. Such SWNT compositions include compositions of the formula

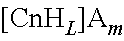

where n, L and m are as described above, A is selected from —OY, —NHY, —CR′₂—OY, —C(O)OY, —C(O)NR′Y, —C(O)SY, or —C(O)Y, wherein Y is an appropriate functional group of a protein, a peptide, an enzyme, an antibody, a nucleotide, an oligonucleotide, an antigen, or an enzyme substrate, enzyme inhibitor or the transition state analog of an enzyme substrate or is selected from —R′OH, —R′NH₂, —R′SH, —R′CHO, —R′CN, —R′X, —R′SiR′₃, —RSi—(OR′)_{y}—R′_{(3-y)}, —R′Si—(O—SiR′₂)—OR′, —R′—R″, —R′—NCO, (C₂H₄O)_{w}Y, —(C₃H₆O)_{w}H, —(C₂H₄O)_{w}R′, —(C₃H₆O)_{w}R′ or —(C₃H₆O)_{w}R″, wherein w is an integer greater than one and less than 200. R′ and R″ are defined above.

The functional SWNTs and other carbon nanotubes of structure shown immediately above may also be functionalized to produce SWNT compositions having the formula

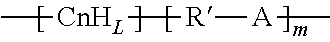

where n, L, m, R′ and A are as defined above.

The conductive precursor composition and/or the conductive composition may also include SWNTs and other carbon nanotubes upon which certain cyclic compounds are adsorbed. These include SWNT compositions of matter of the formula

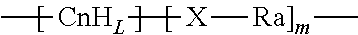

where n is an integer, L is a number less than 0.1 n, m is less than 0.5 n, a is zero or a number less than 10, X is a polynuclear aromatic or a polyheteronuclear aromatic moiety and R is as recited above. Preferred cyclic compounds are planar macrocycles such as re porphyrins and phthalocyanines.

The adsorbed cyclic compounds may be functionalized. Such SWNT compositions include compounds of the formula

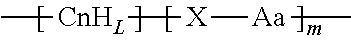

where m, n, L, a, X and A are as defined above and the carbons are on the SWNT or on other nanotubes such as MWNTs, VGCF, or the like.

Without being bound to a particular theory, the functionalized SWNTs and other carbon nanotubes are better dispersed into the organic polymers because the modified surface properties may render the carbon nanotube more compatible with the organic polymer, or, because the modified functional groups (particularly hydroxyl or amine groups) are bonded directly to the organic polymer as terminal groups. In this way, organic polymers such as polycarbonates, polyamides, polyesters, polyetherimides, or the like, bond directly to the carbon nanotubes, thus making the carbon nanotubes easier to disperse with improved adherence to the organic polymer.

Functional groups may generally be introduced onto the outer surface of the SWNTs and the other carbon nanotubes by contacting the respective outer surfaces with a strong oxidizing agent for a period of time sufficient to oxidize the surface of the SWNTs and other carbon nanotubes and further contacting the respective outer surfaces with a reactant suitable for adding a functional group to the oxidized surface. Preferred oxidizing agents are comprised of a solution of an alkali metal chlorate in a strong acid. Preferred alkali metal chlorates are sodium chlorate or potassium chlorate. A preferred strong acid used is sulfuric acid. Periods of time sufficient for oxidation are about 0.5 hours to about 24 hours.

Carbon black may also be used in the conductive precursor composition and/or the conductive composition. Preferred carbon blacks are those having average particle sizes less than about 100 nm, preferably less than about 70 nm, more preferably less than about 50 nm. Preferred conductive carbon blacks may also have surface areas greater than about 200 square meter per gram (m2/g), preferably greater than about 400 m2/g, yet more preferably greater than about 1000 m2/g. Preferred conductive carbon blacks may have a pore volume (dibutyl phthalate absorption) greater than about 40 cubic centimeters per hundred grams (cm³/100 g), preferably greater than about 100 cm³/100 g, more preferably greater than about 150 cm³/100 g. Exemplary carbon blacks include the carbon black commercially available from Columbian Chemicals under the trade name Conductex®; the acetylene black available from Chevron Chemical, under the trade names S.C.F. (Super Conductive Furnace) and E.C.F. (Electric Conductive Furnace); the carbon blacks available from Cabot Corp. under the trade names Vulcan XC72 and Black Pearls; and the carbon blacks commercially available from Akzo Co. Ltd under the trade names Ketjen Black EC 300 and EC 600. Preferred conductive carbon blacks may be used in amounts from about 0.1 wt % to about 25 wt % based on the total weight of the conductive precursor composition and/or the conductive composition.

Solid conductive metallic fillers may also optionally be used in the conductive precursor composition and/or the conductive composition. These may be electrically conductive metals or alloys that do not melt under conditions used in incorporating them into the organic polymer and fabricating finished articles therefrom. Metals such as aluminum, copper, magnesium, chromium, tin, nickel, silver, iron, titanium, and mixtures comprising any one of the foregoing metals can be incorporated into the organic polymer as conductive fillers. Physical mixtures and true alloys such as stainless steels, bronzes, and the like, may also serve as conductive filler particles. In addition, a few intermetallic chemical compounds such as borides, carbides, and the like, of these metals, (e.g., titanium diboride) may also serve as conductive filler particles. Solid non-metallic, conductive filler particles such as tin-oxide, indium tin oxide, and the like may also optionally be added to render the organic polymer conductive.

In some embodiments, a size (e.g., the average size, median size, or minimum size) of the high aspect ratio carbon elements along one or two major dimensions may be at least 0.1 μm, 0.5 μm, 1 μm, 5 μm, 10 μm, 50 μm, 100 μm, 200 μm, 300, μm, 400 μm, 500 μm, 600 μm, 7000 μm, 800 μm, 900 μm, 1,000 μm or more. For example, in some embodiments, the size (e.g., the average size, median size, or minimum size) of the elements may be in the range of 1 μm to 1,000 μm, or any subrange thereof, such as 1 μm to 600 μm.

In some embodiments, the size of the elements can be relatively uniform. For example, in some embodiments, more than 50%, 60%, 70%, 80%, 90%, 95%, 99% or more of the elements may have a size along one or two major dimensions within 10% of the average size for the elements.

Functionalizing the nanocarbons generally includes surface treatment of the nanocarbons. Surface treatment may be performed by any suitable technique such as those described herein or known in the art. Functional groups applied to the nanocarbons may be selected to promote adhesion between the active material particles and the nanocarbons. For example, in various embodiments the functional groups may include carboxylic groups, carbonyl groups, ester groups, hydroxyl groups, amine groups, silane groups, thiol groups, phosphate groups, or combinations thereof.

In some embodiments, the functionalized carbon elements are formed from dried (e.g., lyophilized) aqueous dispersion comprising nanoform carbon and functionalizing material such as a surfactant. In some such embodiments, the aqueous dispersion is substantially free of materials that would damage the carbon elements, such as acids.

In some embodiments, surface treatment of the high aspect ratio carbon elements includes a thin polymeric layer disposed on the carbon elements that promotes adhesion of the active material to the network. In some such embodiments the thin polymeric layer comprises a self-assembled and or self-limiting polymer layer. In some embodiments, the thin polymeric layer bonds to the active material, e.g., via hydrogen bonding.

In some embodiments the thin polymeric layer may have a thickness in the direction normal to the outer surface of the carbon elements of less 3 times, 2 times, 1 time, 0.5 times, 0.1 times that the minor dimension of the element (or less).

In some embodiments, the thin polymeric layer includes functional groups (e.g., side functional groups) that bond to the active material, e.g., via non-covalent bonding such a 7E-7E bonding. In some such embodiments the thin polymeric layer may form a stable covering layer over at least a portion of the elements.

In some embodiments, the thin polymeric layer on some of the elements may bond with a current collector or and adhesion layer disposed thereon and underlying an active layer containing the energy storage (i.e., active) material. For example, in some embodiments, the thin polymeric layer includes side functional groups that bond to the surface of the current collector or adhesion layer, e.g., via non-covalent bonding such a 7E-7E bonding. In some such embodiments, the thin polymeric layer may form a stable covering layer over at least a portion of the elements. In some embodiments, this arrangement provides for excellent mechanical stability of the electrode.

In some embodiments, the polymeric material is miscible in solvents of the type described in the examples above. For example, in some embodiments the polymeric material is miscible in a solvent that includes an alcohol such as methanol, ethanol, or 2-propanol (isopropyl alcohol, sometimes referred to as IPA) or combinations thereof. In some embodiments, the solvent may include one or more additives used to further improve the properties of the solvent, e.g., low boiling point additives such as acetonitrile (ACN), de-ionized water, and tetrahydrofuran. In this example, the mixture is formed in an NMP free solvent.

Suitable examples of materials which may be used to form the polymeric layer include water soluble polymers such as polyvinylpyrrolidone. In some embodiments, the polymeric material has a low molecular mass, e.g., less than or equal to 1,000,000 g/mol, 500,000 g/mol, 100,000 g/mol, 50,000 g/mol, 10,000 g/mol, 5,000 g/mol, 2,500 g/mol or less.

Note that the thin polymeric layer described above is qualitatively distinct from bulk polymer binder used in conventional electrodes. Rather than filling a significant portion of the volume of the active layer, the thin polymeric layer resides on the surface of the high aspect ratio carbon elements, leaving the vast majority of the void space within available to hold active material particles.

For example, in some embodiments, the thin polymeric layer has a maximum thickness in a direction normal to an outer surface of the network of less than or equal to 1 time, 0.5 times, 0.25 times, or less of the size of the carbon elements 201 along their minor dimensions. For example, in some embodiments the thin polymeric layer may be only a few molecules thick (e.g., less than or equal to 100, 50, 10, 5, 4, 3, 2, or even 1 molecule(s) thick). Accordingly, in some embodiments, less than 10%, 5%, 1%, 0.1%, 0.01%, 0.001% or less of the volume of the active layer 100 is filled with the thin polymeric layer.

In yet further exemplary embodiments, the surface treatment may be formed a layer of carbonaceous material which results from the pyrolyzation of polymeric material disposed on the high aspect ratio carbon elements. This layer of carbonaceous material (e.g., graphitic or amorphous carbon) may attach (e.g., via covalent bonds) to or otherwise promote adhesion with the active material particles. Examples of suitable pyrolyzation techniques are described in U.S. patent application Ser. No. 63/028,982 filed May 22, 2020. One suitable polymeric material for use in this technique is polyacrylonitrile (PAN).

TABLE I
Exemplary Parameters for First Step

| Parameters | Motivations | Value | Comment |
|---|---|---|---|
| Temperature | to fully dissolve | R.T. | no heat needed for some |
| | surfactant (CTAPF6) | | solvents (ethanol) |
| | | 45° C. | designed for IPA as solvent |
| | | (35 to 70° C.) | |
| Duration | | 60 min | Depending on mix efficiency |
| | | (15 to 75 mins) | |
| | | 100 min | initially designed for larger |
| | | (80 to 120 mins) | volume ≥1.0 L |
| Dispersion | should be adjusted to | ~700 rpm | for low viscosity/small |
| Speed | 1) make sure all salts | (300 to 900 rpm) | volume |
| | dissolved, 2) avoid | 1000 rpm | |
| | unwanted CNT | (800 to 1200 rpm) | |
| | precipitation | ~1300 rpm | for high viscosity/high volume/ |
| | | (1100 to 1500 rpm) | no temperature heat |

Referring to FIG. 6, in the second step 42, active material is added to the carbon dispersion formed in the first step 41. The active material may be provided as particles or in other suitable forms.

In various embodiments, the active material may include any active material suitable for use in energy storage devices, including metal oxides such as lithium metal oxides. For example, the active material may include lithium cobalt oxide (LCO, sometimes called “lithium cobaltate” or “lithium cobaltite,” is a chemical compound with one variant of possible formulations being LiCoO₂); lithium nickel manganese cobalt oxide (NMC, with a variant formula of LiNiMnCo); lithium manganese oxide (LMO with variant formulas of LiMn₂O₄, Li₂MnO₃ and others); lithium nickel cobalt aluminum oxide (LiNiCoAlO₂ and variants thereof as NCA) and lithium titanate oxide (LTO, with one variant formula being Li₄Ti₅O₁₂); lithium iron phosphate oxide (LFP, with one variant formula being LiFePO₄), lithium nickel cobalt aluminum oxide (and variants thereof as NCA) as well as other similar other materials. Other variants of the foregoing may be included.

In some embodiments where NMC is used as an active material, nickel rich NMC may be used. For example, in some embodiments, the variant of NMC may be LiNiₓMn_{y}Co_{1-x-y}, where x is equal to or greater than about 0.7, 0.75, 0.80, 0.85, or more. In some embodiments, so called NMC811 may be used, where in the foregoing formula x is about 0.8 and y is about 0.1.

In some embodiments, the active material includes other forms of lithium nickel manganese cobalt oxide (LiNiₓMn_{y}Co_{z}O₂). For example, common variants such as, without limitation: NMC 111 (LiNi_{0.33}Mn_{0.33}Co_{0.33}O₂); NMC 532 (LiNi_{0.5}Mn_{0.3}Co_{0.2}O₂); NMC 622 (LiNi_{0.6}Mn_{0.2}Co_{0.2}O₂); and others may be used.

In some embodiments, e.g., where the electrode is used as an anode, the active material may include graphite, hard carbon, activated carbon, nanoform carbon, silicon, silicon oxides, carbon encapsulated silicon nanoparticles. In some such embodiments an active layer of the electrode may be intercalated with lithium, e.g., using pre-lithiation methods known in the art.

In some embodiments, the techniques described herein may allow for the active layer be made of in large portion of material in the active layer, e.g., greater than 75%, 80%, 85%, 90%, 95%, 99%, 99.5%, 99.8% or more by weight, while still exhibiting excellent mechanical properties (e.g., lack of delamination during operation in an energy storage device of the types described herein). For example, in some embodiments, the active layer may have such aforementioned high amount of active material and a large thickness (e.g., greater than 50 μm, 100 μm, 150 μm, 200 μm, or more), while still exhibiting excellent mechanical properties (e.g., a lack of delamination during operation in an energy storage device of the types described herein).

Particles of the active material may be characterized by a median particle sized in the range of e.g., 0.1 μm and 50 micrometers μm, or any subrange thereof. The particles of active material may be characterized by a particle size distribution which is monomodal, bi-modal or multi-modal particle size distribution. The particles of active material may have a specific surface area in the range of 0.1 meters squared per gram (m²/g) and 100 meters squared per gram (m²/g), or any subrange thereof. In some embodiments, the active layer may have mass loading of particles of active material e.g., of at least 20 mg/cm², 30 mg/cm², 40 mg/cm², 50 mg/cm², 60 mg/cm², 70 mg/cm², 80 mg/cm², 90 mg/cm², 100 mg/cm², or more.

TABLE II
Parameters for Addition of Active Material

| Parameters | Motivations | Value | Comment |
|---|---|---|---|
| Dispersion | should be | ~700 rpm | for low viscosity/small volume |
| Speed | maximized | (600 to 1000 rpm) | or dry room condition, no NCM |
| | while avoid | | aggregation |
| | splash | 1000 rpm | |
| | | (800 to 1200 rpm) | |
| | | ~1300 rpm | for high viscosity/high volume/ |
| | | (1100 to 1500 rpm) | no heat |

In the third step 43, dispersants and additives are added to the mixture. An example of a dispersant is PVP. Polyvinylpyrrolidone (PVP), also commonly called “polyvidone” or “povidone,” is a water-soluble polymer made from the monomer N-vinylpyrrolidone. Generally, the dispersant serves as an emulsifier and disintegrant for solution polymerization and as a surfactant, reducing agent, shape controlling agent and dispersant in nanoparticle synthesis and their self-assembly. Another example of a dispersant includes AQUACHARGE, which is a tradename for an aqueous binder for electrodes, that was developed by applying water-soluble resin technology. AQUACHARGE is produced by Sumitomo Seika Chemicals Co., Ltd. of Hyogo Japan. A similar example is provided in U.S. Pat. No. 8,124,277, entitled “Binder for electrode formation, slurry for electrode formation using the binder, electrode using the slurry, rechargeable battery using the electrode, and capacitor using the electrode,” and incorporated herein by reference in it's entirety. Further examples include polyacrylic acid (PAA) which is a synthetic high-molecular weight polymer of acrylic acid as well as sodium polyacrylate which is a sodium salt of polyacrylic acid.

TABLE III
Dispersant Additions and Mixing

| Parameters | Motivations | Value | Comment |
|---|---|---|---|
| Duration | | 60 min | Low Specific Capacity (mAh/g) for |
| | | (40 to 80 mins) | Cathode and Anode Electrodes |
| | | 120 min | High Specific Capacity (mAh/g) for |
| | | (90 to 150 mins) | Cathode and Anode Electrodes |
| Dispersion | should be | ~800 rpm | for low viscosity/small volume |
| Speed | maximized | (600 to 1000 rpm) | |
| | while avoid | 1000 rpm | Experiments show 1300-1400 rpm is |
| | splash | (800 to 1200 rpm) | better for mixing dispersant additives |
| | | | (ex. PVP) in slurry |
| | | ~1300-1400 rpm | for high viscosity/high volume |
| | | (1200 to 1600 rpm) | |

TABLE IV
Target Viscosity Range of Slurry

| Shear Rate (rpm) | Viscosity (mPa s) |
|---|---|
| 6 | 20000-10000 |
| 12 | 6000-3000 |
| 30 | 3000-1500 |
| 60 | 1200-800 |

In the fourth step 44, coating of the current collector with the slurry and then drying of the coated assembly occurs. In some embodiments, the final slurry may be formed into a sheet, and coated directly onto the current collector or an intermediate layer such as an adhesion layer as appropriate. In some embodiments, the final slurry may be applied to through a slot die to control the thickness of the applied layer. In other embodiments, the slurry may be applied and then leveled to a desired thickness, e.g., using a doctor blade. A variety of other techniques may be used for applying the slurry. For example, coating techniques may include, without limitation: comma coating; comma reverse coating; doctor blade coating; slot die coating; direct gravure coating; air doctor coating (air knife); chamber doctor coating; off set gravure coating; one roll kiss coating; reverse kiss coating with a small diameter gravure roll; bar coating; three reverse roll coating (top feed); three reverse roll coating (fountain die); reverse roll coating and others.

The viscosity of the final slurry may vary depending on the application technique. For example, for comma coating, the viscosity may range between about 1,000 cps to about 200,000 cps. Lip-die coating provides for coating with slurry that exhibits a viscosity of between about 500 cps to about 300,000 cps. Reverse-kiss coating provides for coating with slurry that exhibits a viscosity of between about 5 cps and 1,000 cps. In some applications, a respective layer may be formed by multiple passes.

TABLE V
Coating and Drying

| Parameters | Motivations | Value | Comment |
|---|---|---|---|
| Blade dispersion | resolve the active | blade dispersion | lower specific capacity, higher areal |
| and mixing | material (e.g., NMC | | loading in the last portion of slurry. |
| before coating | material) | mixing up and | mixing up and down the slurry, right |
| | high density induced | down right before | before each coating, very uniform and |
| | non uniformity issue | coating | consistent loading with similar active |
| | | | material (NMC/Graphite/SiOx) |
| | | | content. |
| Coating Speed | higher coating speed is | 30 mm/s | initial value used |
| | good for 3D nano- | | |
| | carbon based slurry | | |
| | Shear thinning behavior | 60 mm/s | better coating compared to 30 mm/s |
| | of 3D nano-carbon | 120 mm/s | reduce the chunk significantly |
| | based slurry | (60-180 mm/s) | |
| | | 180 mm/s | May be used for certain active |
| | | | materials |

In the fifth step 45, calendering is performed. In some embodiments, the layer formed from the final slurry may be compressed (e.g., using a calendering apparatus) before or after being applied to the current collector (directly or upon an intermediate layer). In some embodiments, the slurry may be partially or completely dried (e.g., by applying heat, vacuum or a combination thereof) prior to or during the calendering (i.e., compression) process. For example, in some embodiments, the layer may be compressed to a final thickness (e.g., in the direction normal to the current collector layer 101) of less than 90%, 80%, 70%, 50%, 40%, 30%, 20%, 10% or less of its pre-compression thickness.

In various embodiments, when a partially dried layer is formed during a coating or compression process, the layer may be subsequently fully dried, (e.g., by applying heat, vacuum or a combination thereof). In some embodiments, substantially all of the solvent is removed from the active layer 100.

In some embodiments, solvents used in formation of the slurries are recovered and recycled into the slurry-making process.

In some embodiments, the layer may be compressed, e.g., to break some of the constituent high aspect ratio carbon elements or other carbonaceous material to increase the surface area of the respective layer. In some embodiments, this compression treatment may increase one or more of adhesion, ion transport rate, and surface area. In various embodiments, compression can be applied before or after the layer is applied to or formed on the electrode.

In some embodiments where calendaring is used to compress the layer, the calendaring apparatus may be set with a gap spacing equal to less than 90%, 80%, 70%, 50%, 40%, 30%, 20%, 10% or less of the pre-compression thickness of the layer (e.g., set to about 33% of the pre-compression thickness of the layer). The calendar rolls can be configured to provide suitable pressure, e.g., greater than 1 ton per cm of roll length, greater than 1.5 ton per cm of roll length, greater than 2.0 ton per cm of roll length, greater than 2.5 ton per cm of roll length, or more. In some embodiments, the post compression layer will have a density in the range of 1 g/cc to 10 g/cc, or any subrange thereof such as 2.5 g/cc to 4.0 g /cc. In some embodiments the calendaring process may be carried out at a temperature in the range of 20° C. to 140° C. or any subrange thereof. In some embodiments the layer may be pre-heated prior to calendaring, e.g., at a temperature in the range of 20° C. to 100° C. or any subrange thereof.

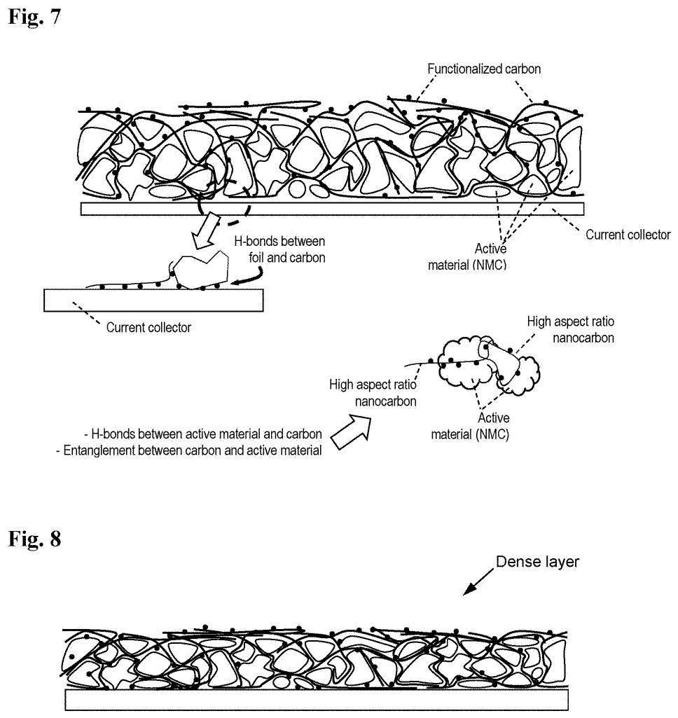

Aspects of fabrication of the layer on the current collector are shown in FIGS. 7 and 8. In FIG. 7, it may be seen that active material is dispersed within a network of functionalized carbon. The network of functionalized carbon with the active material is disposed on the current collector. Referring also to FIG. 8, it may be seen that after a calendaring process, the combination of active material and functionalized carbon nanomaterials result in a dense layer disposed on the current collector.

TABLE VI
Calendering Parameters

| Parameters | Motivations | Value | Comment |
|---|---|---|---|
| Gap | | 10 μm | |
| | | (0 to 30 μm) | |
| Times | flip side for better | 2 | initial value used, good for high mass |
| | uniformity | | loading based electrodes (≥40 mg/cm²) |
| | | | loading. |
| | increase times for | 4 | moderate density and good uniformity |
| | higher density | 8 | for reaching ≥3.4 g/cc cathode electrodes |
| | | | for low mass loading based electrodes |
| | | | (≤15 mg/cm²) loading |

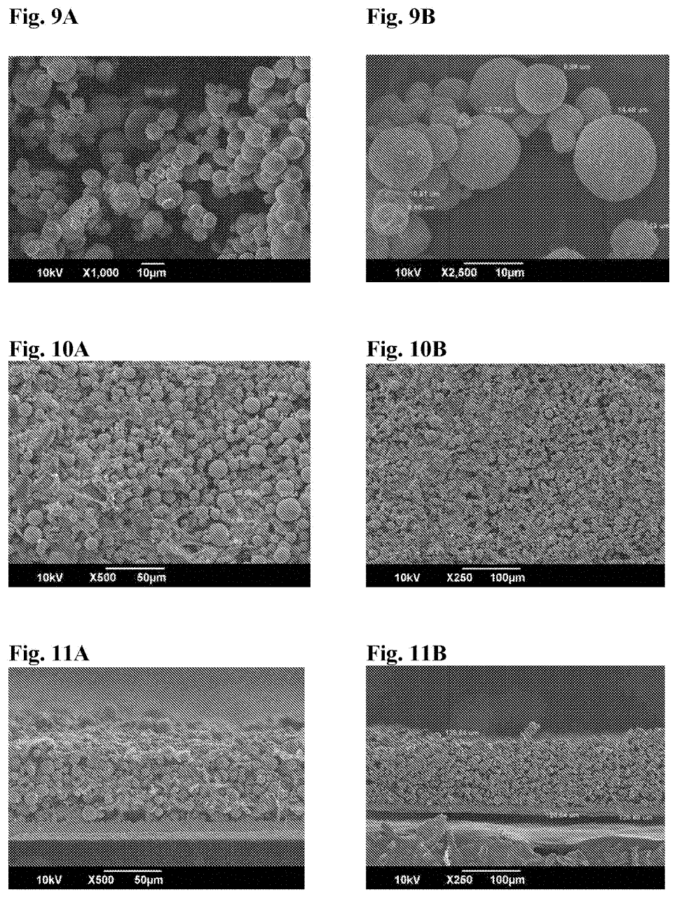

FIGS. 9 though 15 are micrographs depicting aspects of active materials and cross sections of layers of active materials fabricated according to the teachings here. FIGS. 9A and 9B, collectively referred to herein as FIG. 9, depict powders rich in nickel and useful in the active materials. FIGS. 10A and 10B, collectively referred to herein as FIG. 10, depict surface morphology of electrodes fabricated with NMC materials that were rich in nickel. In these examples, the electrodes were viewed after the coating and drying process. The materials were fabricated with 1% surfactant (CTAPF6); 0.25% dispersant (PVP) and 3% 3D nano-carbon materials. The active materials were coated on a single side of aluminum foil as the current collector. FIGS. 11A and 11B, collectively referred to herein as FIG. 11, depict the electrode of FIG. 10 from a side cross-sectional view. FIGS. 12A and 12B, collectively referred to herein as FIG. 12, depict the electrode of FIGS. 10 and 11 from a mid-section cross-sectional view.

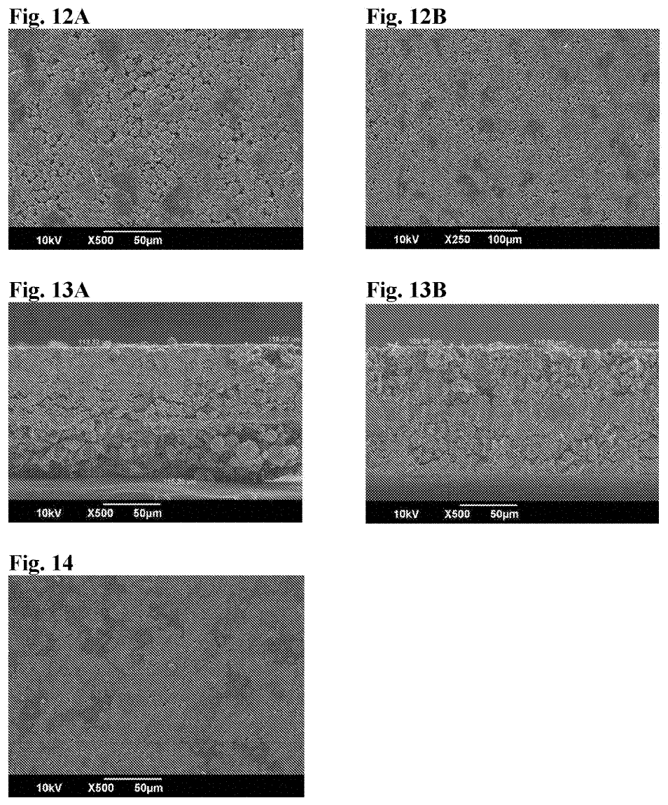

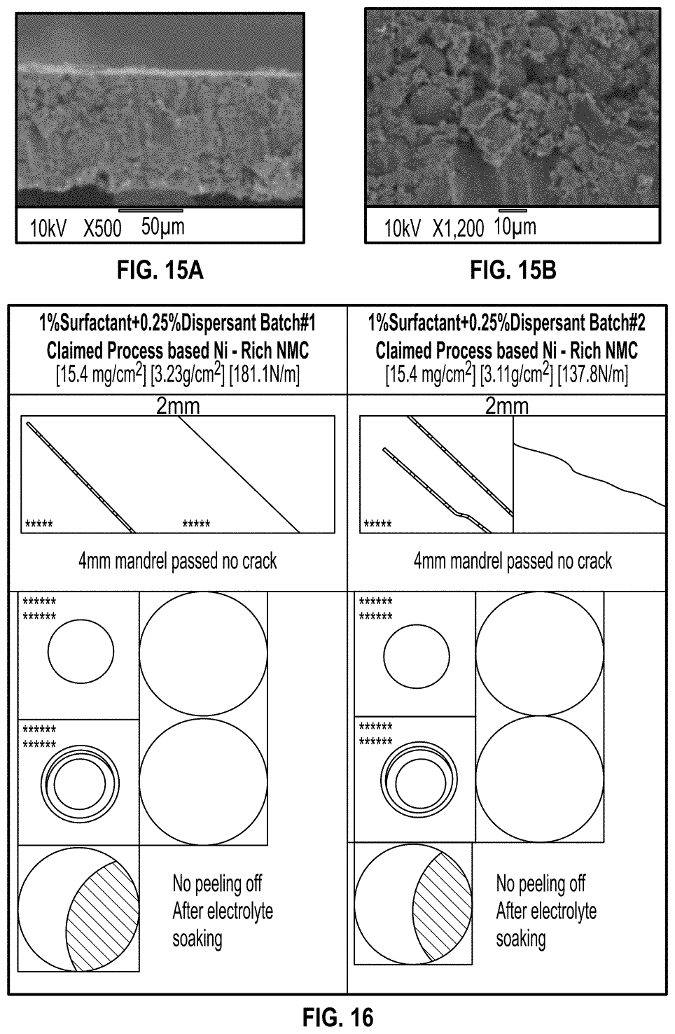

FIGS. 13A and 13B, collectively referred to herein as FIG. 13, depict cross-sectional side views of electrodes fabricated with NMC materials that were rich in nickel. In these examples, the electrodes were viewed after the coating and drying process. The materials were fabricated with 1% surfactant (CTAPF6); 0.25% dispersant (PVP) and 3% 3D nano-carbon materials. The active materials were coated on both sides of an aluminum foil sheet as the current collector. Mass loading of the active material was about 15 mg/cm² and press density was about 3.5 gm/cm³. FIG. 14, depicts a top cross-sectional view the electrode of FIG. 13. FIGS. 15A and 15B, collectively referred to herein as FIG. 15, depict another top cross-sectional view of the electrode of FIGS. 13 and 14. FIG. 16 is a graphic depicting aspects of mechanical testing for two separate batches of active materials.

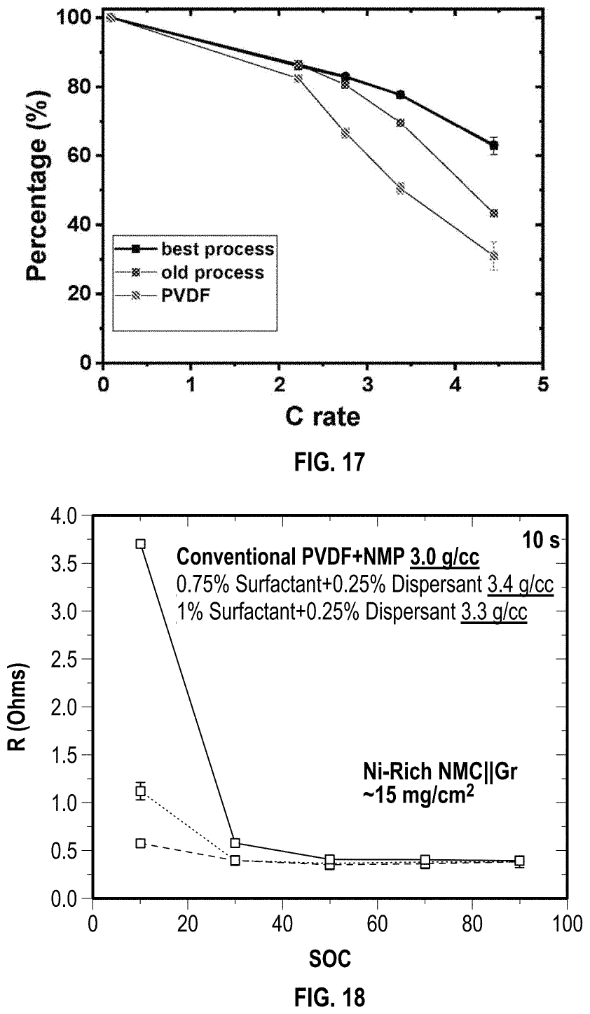

FIG. 17 is a graph depicting is C rate for a half-cell constructed according to the teachings herein. The half-cell included areal loading of NCM active material that was 22.5 mg/cm². In this example, the “best process” curve represents binder-free electrodes fabricated according to the teachings herein. The “old process” curve represents binder-free electrodes fabricated without these surfactants and dispersants disclosed herein. The “PVDF” curve represents performance for cells using electrodes fabricated with prior art technology. In this example, the half-cell was of pouch cell construction. Initial specific and C-Rate test results at provided in the table below. The working electrode size was 45×45 mm, Li counter electrode 46×46 mm. Electrolyte was 1M LiPF6 in EC/DMC (1/1 by vol)+1% VC.

Data for FIG. 17

| | | Initial | |
|---|---|---|---|
| | | Discharge | |
| Electrode Manufacturing Process | Press | Specific | ICE, |
| (~15 mg/cm²) | Density | Capacity | % |
| 1% Surfactant + 0.25% Dispersant + | 3.1 g/cc | 204 mAh/g | 98% |
| 3%-3D nano-carbon | | | |
| 1% Surfactant + 0.25% Dispersant + | 3.5 g/cc | 204 mAh/g | 98.5% |
| 3%-3D nano-carbon | | | |
| Conventional PVDF + NMP process | 3.5 g/cc | 194 mAh/g | 94.2% |

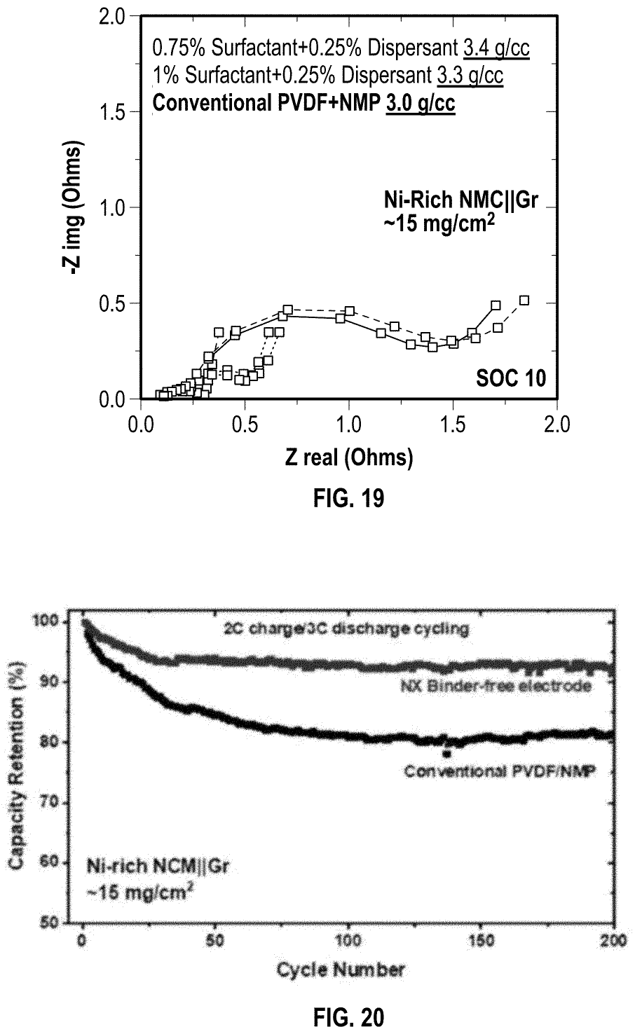

In FIG. 18, test results are shown for a full pouch cell. In this example, the cathode was Ni-rich NMC with 45×45 mm and the anode was graphite electrodes with 46×46 mm. The electrolyte was 1M LiPF6 in EC/DMC (1/1 by vol)+1% VC. N/P ratio=˜1.1. It may be seen that HPPC resistance is much lower compared with traditional PVDF process. As shown in FIG. 19, lower charge resistance in cathodes according to the teachings herein results in improved performance at ten percent state-of-charge. FIG. 20 shows that cycling stability is improved with a cathode fabricated according to the teachings herein.

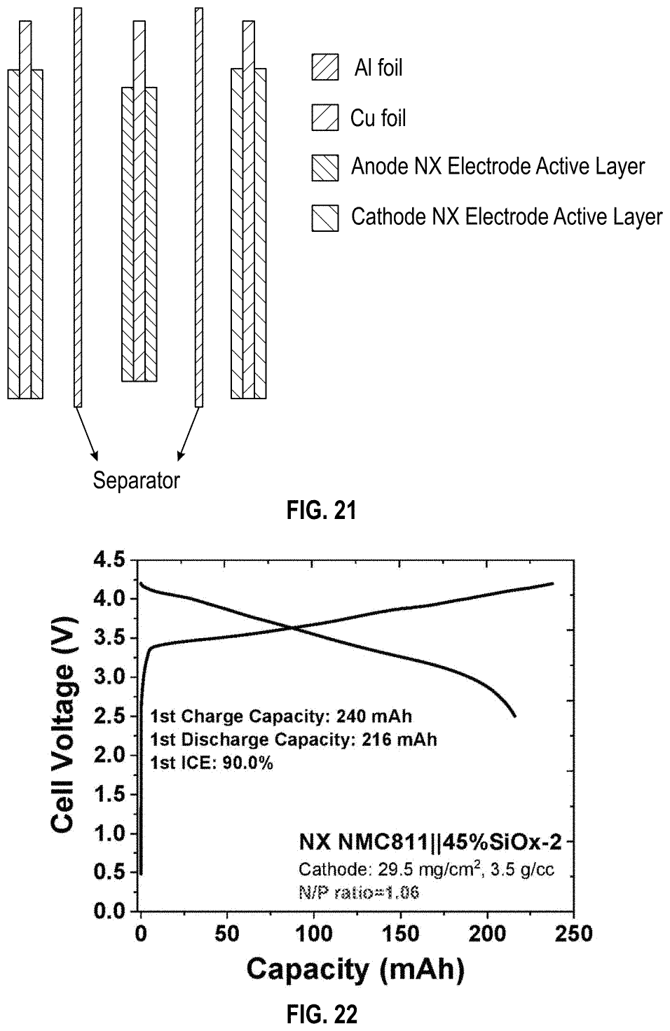

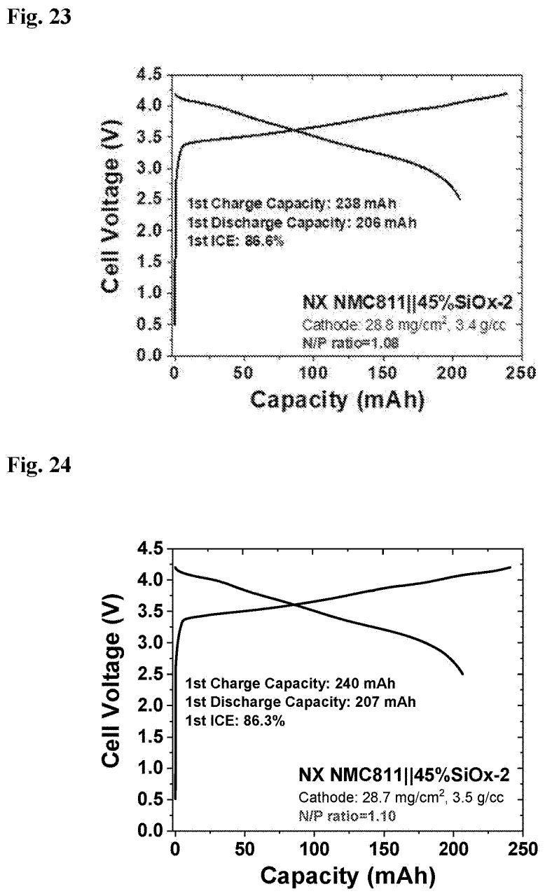

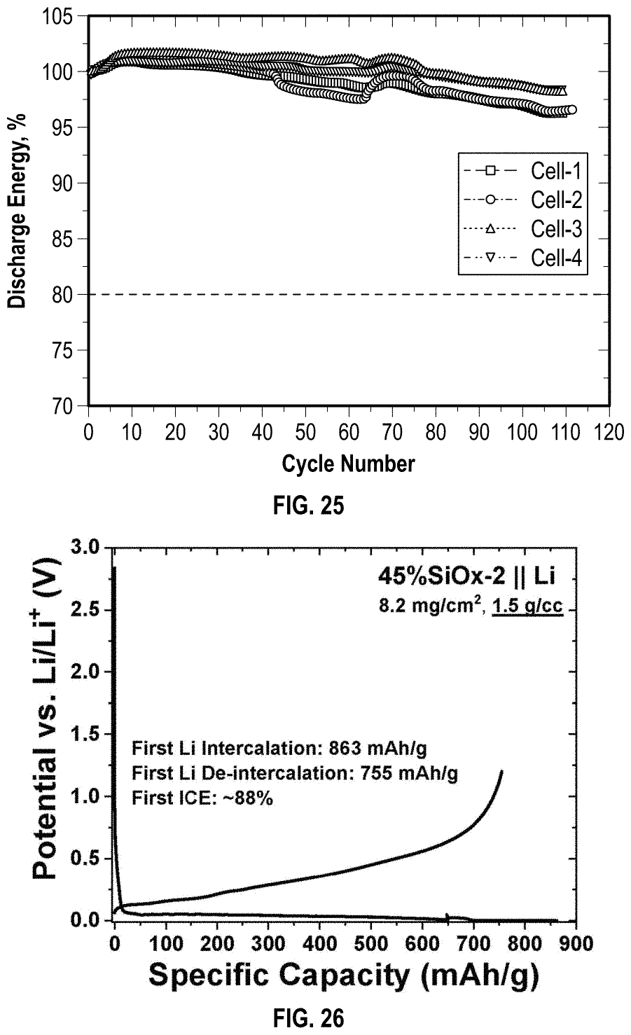

Another pouch cell was constructed for testing. Structure of the pouch cell is set forth in FIG. 21. In this second embodiment, the cathode was Ni-rich NMC with 45×45 mm, 28-30 mg/cm² mass loading, and the anode was a combination of graphite/SiOₓ (45% SiOₓ) electrodes with 46×46 mm, 8-9 mg/cm² mass loading. The electrolyte was 1.1M LiPF6 in PC:FEC:EMC:DEC=20:10:50:20. N/P ratio=˜1.04 to 1.10. Both NMC cathode and 45% SiOx anode electrode manufacturing process were used with the process set forth herein and use a hybrid surfactant and dispersant combined with 3D nano-carbon matrix. The Li-ion battery full cell specific energy was about 332 Wh/kg with 90% pouch cell package efficiency, and 351 Wh/kg if the package efficiency increases to 95%. The energy density was about 808 Wh/L with 90% pouch cell package efficiency and 10% pouch cell volume expansions, and the energy density was about 853 Wh/L with 95% pouch cell package efficiency and 10% pouch cell volume expansions. The initial 1st cycle charge specific capacity of the cathode and anode based on claimed electrode manufacturing process was about 228 mAh/g and 852 mAh/g; the initial 1st cycle discharge specific capacity of the cathode and anode based on claimed electrode manufacturing process was about 210 mAh/g and 750 mAh/g. LiB full cell capacity in this example is 1st charge capacity 240 mAh, and 1st discharge capacity 216 mAh from 4.2 to 2.5 V under 0.1C-Rate constant current charge-discharge. The initial coulombic efficiency is about ˜90%. Aspects of this data and electrical performance for this cell are set forth in FIGS. 22 through 26.

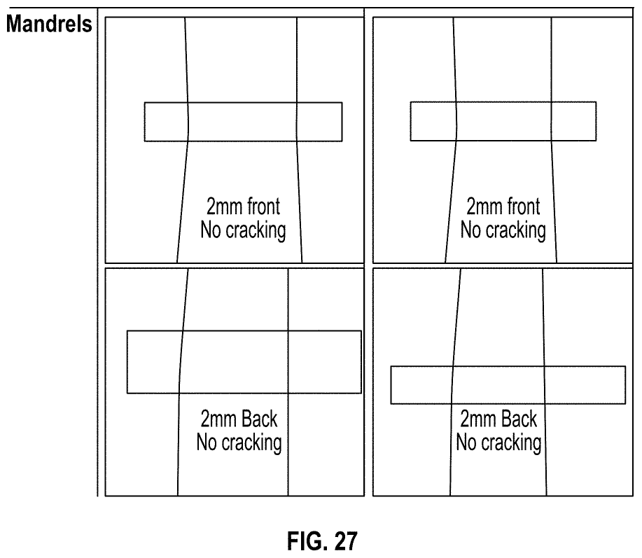

FIG. 27 is a graph containing a series of photographs. As may be seen in FIG. 27, the resulting electrodes did not exhibit cracking or stress as may commonly arise with some physical tests. Further aspects of the test cell are set forth in the table below.

| Cell NX NMC811 ∥ 45% SiOx−2 | Cathode | Anode | Unit |
|---|---|---|---|
| Active Layer Weight | 1.194 | 0.344 | g |
| Al Foil weight | 0.086 | | g |
| Cu Foil weight | | 0.173 | g |
| Active Layer Thickness | 0.168 | 0.13 | mm |
| Porosity | 18.30% | 25.00% | |
| Al Foil Thickness | 0.015 | | mm |
| Cu Foil Thickness | | 0.008 | mm |
| Electrolyte weight in electrodes | 0.07470792 | 0.082524 | g |

| | | |
|---|---|---|
| Separator weight | 0.033 | g |
| Separator thickness | 0.04 | mm |
| Electrolyte weight in separator | 0.05517792 | g |
| Total cell weight | 2.04240984 | g |
| Total cell volume | 0.763876 | mL |
| First Discharge Energy from 4.2 to 2.5 V | 0.7548 | Wh |
| Energy Density without packaging | 369.5634369 | Wh/kg |
| Energy Density with packaging (90% packaging efficiency) | 332.6070932 | Wh/kg |
| Eneigy Density with packaging (95% packaging efficiency) | 351.085265 | Wh/kg |
| Eneigy Density without packaging | 988.1184904 | Wh/L |
| Eneigy Density with packaging (91% packaging efficiency) | 899.1878263 | Wh/L |
| Energy Density with packaging (96% packaging efficiency) | 948.5937508 | Wh/L |
| Energy Density with packaging (96% packaging efficiency) | 862.3579553 | Wh/L |
| and 10% volume expansions | | |

From the table above it may be seen that the energy density at 90% packaging efficiency is greater than 325 Watt-hours/kilogram (Wh/kg), preferably greater than 330 Wh/kg. At 95% packaging efficiency the energy density exceeds 340 Wh/kg, preferably exceeds 350 Wh/kg. The energy density without packaging exceed 360 Wh/kg, preferably exceeds 365 Wh/kg.

### EXAMPLE 1

This example was conducted to demonstrate the difference between conventional electrodes that contain polyvinylidene fluoride (PVDF) and those of the instant disclosure that comprise a water soluble polymer (e.g., polyvinylpyrrolidone (PVP)). The cathode contained NMC811 active material that has the formula LiNiₓMn_{y}Co_{1-x-y}, where x is about 0.8 and y is about 0.1. The electrically conducting network comprises carbon nanotubes.

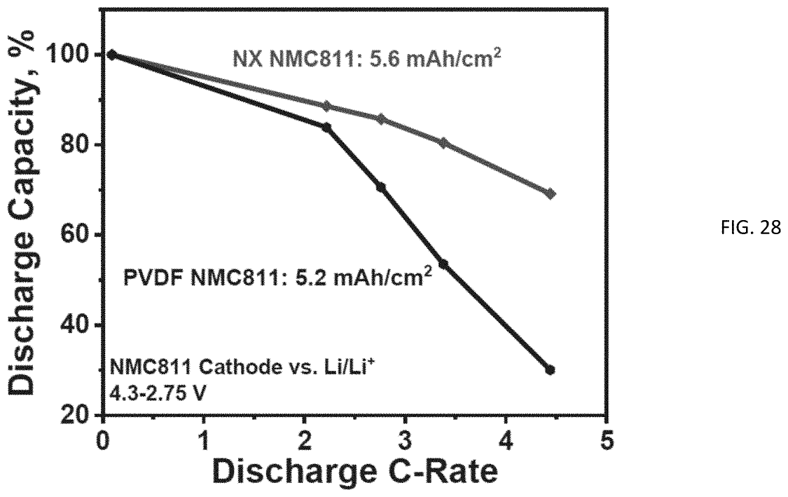

FIG. 28 is a graph that depicts the discharge capacity versus discharge C-rate for a storage device that contains the conventional electrode (polyvinylidene fluoride (PVDF)) and the storage device that contains an electrode that has polyvinylpyrrolidone (PVP). Under a 4.5-rate discharge, the storage device that contains the PVP electrode shows a 69% charge retention capacity (greater than 145 mAh/g) versus the PVDF control sample that displays a 30% charge retention capacity (about 59 mAh/g). The storage device containing the PVP surface treatment with the NMC811 active material improves the performance by at least 2 times compared with the PVDF control device.

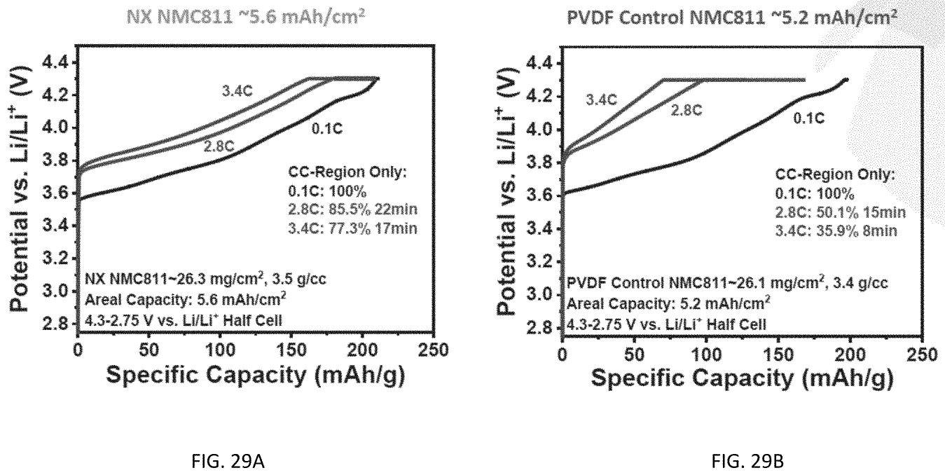

FIG. 29A and 29B depict graphical plots for the electrodes of the instant disclosure (containing PVP) versus the conventional electrode (which contains PVDF) respectively. FIG. 29A is a plot that depicts potential vs Li/Li+ versus specific capacity for the electrode containing PVP, while the FIG. 29B is a plot that depicts potential vs Li/Li+ versus specific capacity for the electrode containing PVDF. Under a 3.4C/min fast-charging in half cells (using Li as a counter electrode), the electrode of the instant disclosure (containing PVP) shows a fast charging capacity that is at least 2 times greater than the conventional electrode that contains PVDF.

Even under high loading of 5.6 mAh/cm², the electrode containing the PVP shows a specific charge capacity of 162 mAh/g while the PVDF control shows only a specific charge capacity of 70 mAh/g.

### EXAMPLE 2

This example demonstrates the use of a water soluble surface treatment containing PVP in an anode. The electrically conducting network comprises carbon nanotubes. The anode active material is a silicon-carbon (Si—C) containing material. The anode was tested for mechanical properties. In an 2 millimeter mandrel test, the anode active layer (which contains PVP and the silicon-carbon (Si—C) containing material displayed a average strength of 235 Newtons per meter with a maximum value of 255 Newtons per meter. The active layer displayed an initial Li charge specific capacity of 1234 mAh/gram and an initial Li discharge specific capacity of 1116 mAh/gram. The initial coulombic efficiency (ICE) value is approximately 90%.

### EXAMPLE 3

In an embodiment, a storage device of cell size 46 mm (L)×46 mm (W)×3.4 mm (T) was used to determine discharge capacity and energy density based on the stack thickness. The cell is a 1.5 Ah cell. The table below displays the results.

| | | | Specific Energy | Energy Density |
|---|---|---|---|---|
| | 1^{st} | | based on Stack + | based on stack |
| | discharge | | Electrolyte weight | thickness |
| | capacity | 1^{st} | w/o packaging | w/expansion |
| Cell# | (mAh) | ICE | (Wh/kg) | (Wh/L) |
| LiB - 1.5Ah#1 | 1645 | ~90% | 325.2 | 816.9 |
| LiB - 1.5Ah#2 | 1668 | ~91% | 328.7 | 829.8 |
| Graphite based | 1650 | ~91% | 250 | 540.7 |
| control* | | | | |

*Comparative sample

The pouch cell package efficiency is about 86% for 9 layers of NMC811 cathode and 10 layers of Si—C anode (e.g., for a 1.5 Ah cell). However, it can be increased to 95% efficiency in large-format pouch cells that are greater than 5 Ah with more stack layers. From the aforementioned data in the Table it may be seen that the silicon-containing anode (5.3 mg/cm2) can improve specific energy and energy density by greater than 30% when compared with a graphite anode (16 mg/cm²) (to match the 24 mg/cm² NMC811 cathode) with the same small pouch cell format and layer numbers.

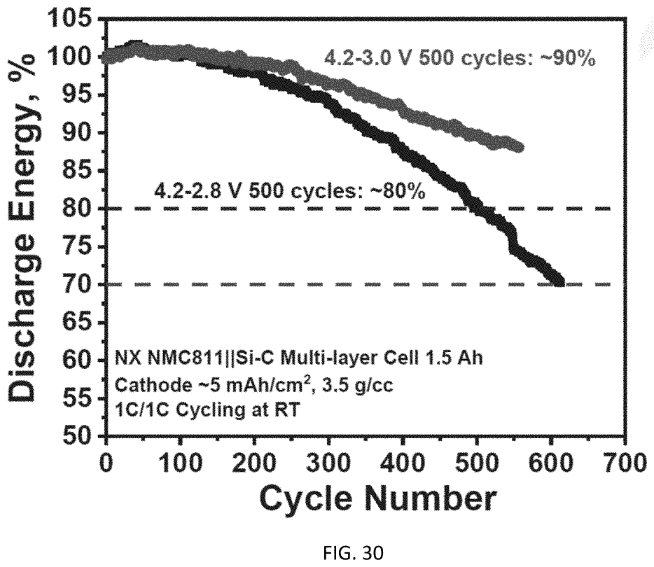

FIG. 30 depicts a plot of discharge energy (expressed as a percentage) versus cycle number. The carbon nanotubes were treated with PVP. The anode active layer contained S—C, while the cathode contained NMC811. The multilayered cell was operated at 1.5 Ah. From the figure, it may be seen that the discharge energy at 3V and at 500 cycles is approximately 90%, while at 2,8 V and 500 cycles it is approximately 80%.

Various other components may be included and called upon for providing for aspects of the teachings herein. For example, additional materials, combinations of materials and/or omission of materials may be used to provide for added embodiments that are within the scope of the teachings herein. A variety of modifications of the teachings herein may be realized. Generally, modifications may be designed according to the needs of a user, designer, manufacturer or other similarly interested party. The modifications may be intended to meet a particular standard of performance considered important by that party.

The appended claims or claim elements should not be construed to invoke 35 U.S.C. § 112(f) unless the words “means for” or “step for” are explicitly used in the particular claim.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. As used herein, the term “exemplary” is not intended to imply a superlative example. Rather, “exemplary” refers to an example of an embodiment that is one of many possible embodiments.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for fabricating an electrode for an energy storage device, the method comprising
heating a mixture of solvent and materials for use as energy storage media;
adding active material to the mixture;
adding dispersant to the mixture to provide a slurry;
coating a current collector with the slurry; and
calendering the coating of slurry on the current collector to provide the electrode.

2. The method as in claim 1, wherein the energy storage media comprises nanocarbons.

3. The method as in claim 1, wherein the energy storage media comprises high aspect ratio carbon elements.

4. The method as in claim 3, wherein length of a major dimension of the high aspect ratio carbon elements is at least one of: 5 times, 10 times, 100 times, 500 times, 1,000 times, 5,000 times, and 10,000 times a minor dimension thereof.

5. The method as in claim 1, wherein the energy storage media comprises nanocarbon that includes a surface treatment thereof.

6. The method as in claim 5, wherein the surface treatment comprises addition of materials to promote adhesion of the active material to the nanocarbons.

7. The method as in claim 5, wherein the surface treatment comprises addition of at least one of a functional group including at least one of a carboxylic group, a hydroxylic group, an amine group, and a silane group.

8. The method as in claim 5, wherein the surface treatment is formed from at least one of a polymeric layer disposed on the nanocarbon and a lyophilized aqueous dispersion comprising nanocarbon and functionalizing material.

9. The method as in claim 8, wherein the functionalizing material comprises a surfactant.

10. The method as in claim 8, further comprising a pyrolized form of the polymeric layer.

11. The method as in claim 1, wherein the active material comprises at least one of lithium cobalt oxide; lithium nickel manganese cobalt oxide; lithium manganese oxide; lithium nickel cobalt aluminum oxide; lithium titanate oxide; lithium iron phosphate oxide; and lithium nickel cobalt aluminum oxide.

12. The method as in claim 1, wherein particles of the active material comprise a median particle size in the range of 0.1 micrometers to 50 micrometers or any subrange thereof.

13. The method as in claim 1, wherein mass loading of the active material mass is at least 20 mg/cm², 30 mg/cm², 40 mg/cm², 50 mg/cm², 60 mg/cm², 70 mg/cm², 80 mg/cm², 90 mg/cm², 100 mg/cm² or more.

14. The method as in claim 1, wherein the dispersant comprises polyvinylpyrrolidone (PVP).

15. The method as in claim 1, wherein the dispersant comprises at least one of an aqueous binder, polyacrylic acid and sodium polyacrylate.

16. The method as in claim 1, further comprising sintering the coating of slurry.

17. An electrode for an energy storage device, the electrode comprising
a coating of energy storage materials disposed onto a current collector, the coating including a suspension of carbon nanoform materials and active materials in a solvent with a dispersant.
